(19) United States
(12) Patent Application Publication
(10) Pub. No.: US 2025/0355127 A1
(43) Pub. Date: Nov. 20, 2025

(54) TOOLS AND METHODS FOR DOWNHOLE ELASTICITY LOGGING USING MECHANICAL MEANS

(71) Applicant: SAUDI ARABIAN OIL COMPANY, Dhahran (SA)

(72) Inventors: Safiyah Fayez ALGHAMDI, Dhahran (SA); Sameeh BATARSEH, Dhahran (SA)

(73) Assignee: SAUDI ARABIAN OIL COMPANY, Dhahran (SA)

(21) Appl. No.: 18/663,605

(22) Filed: May 14, 2024

(51) Int. Cl. G01V 1/04; E21B 49/00; G01V 1/50

(52) U.S. Cl. CPC G01V 1/04; E21B 49/00; G01V 1/50

(57) ABSTRACT

A wellbore logging tool may include a support body and a plurality of arms selectively movable from a retracted position to an extended position with respect to the support body. A hammer is supported at a radially outermost end of each of the arms that is selectively operable to deliver an impulse load to a wall of the wellbore. One or more accelerometers are operably coupled to each hammer to detect an acceleration of the hammer induced by delivering the impulse load. A Hertzian model may be employed to determine characteristics of the wellbore wall from the acceleration of the hammers.

### FIELD OF THE DISCLOSURE

The present disclosure relates generally to downhole logging operations in subterranean wellbores, and more particularly, to measuring characteristics indicative of an elasticity of the subterranean formation as a function of depth in the wellbore.

### BACKGROUND OF THE DISCLOSURE

Wellbores may be drilled to recover natural deposits of oil and gas, as well as other desirable materials that are trapped in subterranean geological formations. Information about these formations is often collected to determine various formation properties such as permeability, temperature, pressure and elasticity. In a geo-mechanical context, elasticity refers to the ability of rocks or other geological formations to deform in response to an applied stress and subsequently revert to their original state when the stress is relieved. Elasticity may serve as a metric for quantifying the inherent stiffness in rocks under varying stress conditions. Understanding these characteristics may have a variety of applications including an assessment of wellbore stability, enabling effective casing, completion and stimulation design and monitoring of the resources in a reservoir accessed by the wellbore.

Methods for assessing downhole elasticity may include acoustic measurements made from the surface and the collection of downhole core samples. Surface measurements provide valuable data but often lack precision and depth specificity because they are influenced by the entire wellbore and surrounding formations, making it challenging to isolate local variations. Core samples, while providing detailed geological information, represent only discrete points within the wellbore and may not capture the full complexity of subsurface rock properties, especially in heterogeneous formations. Direct downhole measurements, on the other hand, may provide real-time, continuous data along the entire length of the wellbore, offering a comprehensive understanding of the well's mechanical environment.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a wellbore system includes a conveyance extending into a wellbore from a surface location and a logging tool coupled to an end of the conveyance such that the logging tool may be moved through the wellbore on the conveyance. The logging tool includes a support body coupled to the conveyance, a plurality of arms selectively movable from a retracted position to an extended position with respect to the support body, a hammer supported at radially outermost end of each of the arms, the hammer selectively operable to deliver an impulse load to a wall of the wellbore when the arms are in the extended position, and one or more accelerometers operably coupled to each hammer and operable to detect an acceleration of the hammer induced by delivering the impulse load.

According to another example embodiment consistent with the present disclosure, a method of conducting a logging operation in a wellbore includes (a) deploying a logging tool to a first target location in the wellbore on a conveyance, (b) moving a plurality of arms carried by the logging tool from a retracted position to an extended position wherein a hammer disposed at a radially outer end of each of the arms engages a wall of the wellbore at a plurality of distinct points at the first target location, (c) delivering an impulse load to the wellbore wall by each of the hammers (d) measuring an acceleration of the hammer during the impulse load, and (e) determining at least one characteristic of the wellbore wall from the acceleration of the hammers at the plurality of distinct points.

According to still another embodiment consistent with the present disclosure, a wellbore logging tool includes a support body elongated in a longitudinal direction, a plurality of arms selectively movable from a retracted position to an extended position with respect to the support body, a hammer supported at radially outermost end of each of the arms, the hammers selectively operable to deliver an impulse load to a wall of the wellbore when the arms are in the extended position, and one or more accelerometers operably coupled to each hammer and operable to detect an acceleration of the hammer induced by delivering the impulse load.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a cross-sectional view of an example wellbore system including a downhole elasticity logging tool conveyed into a wellbore in a retracted configuration where a plurality of arms is folded along a central support body in accordance with one or more aspects of the present disclosure.

FIG. 2 is a perspective view of the logging tool of FIG. 1 in an extended configuration wherein the plurality of arms is unfolded to extend in various radial directions from the central support body.

FIG. 3 is a flow chart illustrating an example procedure for performing a logging operation with the logging tool in accordance with aspects of the present disclosure.

FIG. 4 is a graphical illustration of deformation logs, which may be generated from measurements made by individual arms of the logging tool in accordance with one or more aspects of the present disclosure.

FIG. 5 is a graphical illustration of a stress strain curve for a particular wellbore that may be generated from measurements made by the logging tool.

FIG. 6 is graphical illustration of an impulse hammer curve representing Young's modulus measurements.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to systems and methods for making direct downhole measurements of characteristics indicative of elasticity in a wellbore. The measurements may be made with a logging tool that includes one or more pairs of opposed impact hammers supported at the ends of one or more arms extended across a diameter of a wellbore. The impact hammers may each simultaneously impact the wellbore wall with a known force, and a response may be recorded with an accelerometer or other type of sensor. The response may be stored within the tool or transmitted uphole for immediate analysis and interpretation to gain insights into the elastic properties of the rock formations. Once a desired portion of the wellbore has been logged, the arms of the logging tool may be retracted and the logging tool may be withdrawn from the wellbore. The logging tool offers the ability to measure the mechanical behavior of a geological formation directly downhole, which eliminates inaccuracy by examining the formation's authentic behavior under natural conditions. Direct downhole measurements reduce the need for assumptions and offer representative data specific to the location, making them invaluable for site-specific engineering applications such as wellbore stability analysis or structural foundation design, particularly in non-uniform geologic formations.

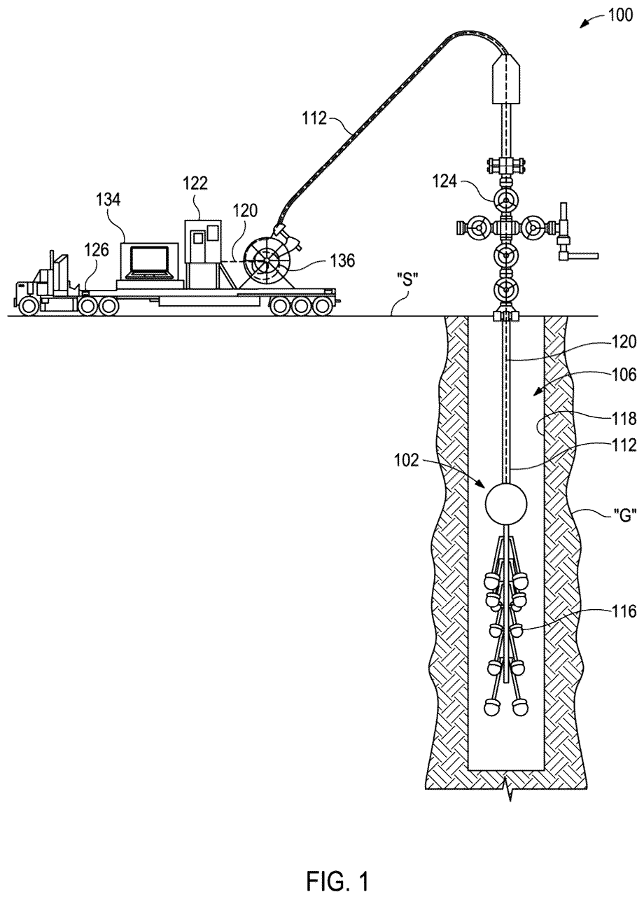

FIG. 1 is a schematic view of an example wellbore system 100 including a downhole elasticity logging tool 102 in accordance with one or more embodiments of the disclosure. The wellbore system 100 is partially disposed in a wellbore 106 extending from a surface location “S” and traversing (penetrating) a geologic formation “G.” In the illustrated example, the wellbore 106 is substantially vertical. In other embodiments, aspects of the disclosure may be practiced in a wide variety of vertical, directional, deviated, slanted and/or horizontal portions therein, and may extend along any trajectory through the geologic formation “G.” As illustrated in FIG. 1, the wellbore 106 is open hole, but in other embodiments, the wellbore 106 may be at least partially lined with a casing string (not shown), without departing from the scope of the disclosure.

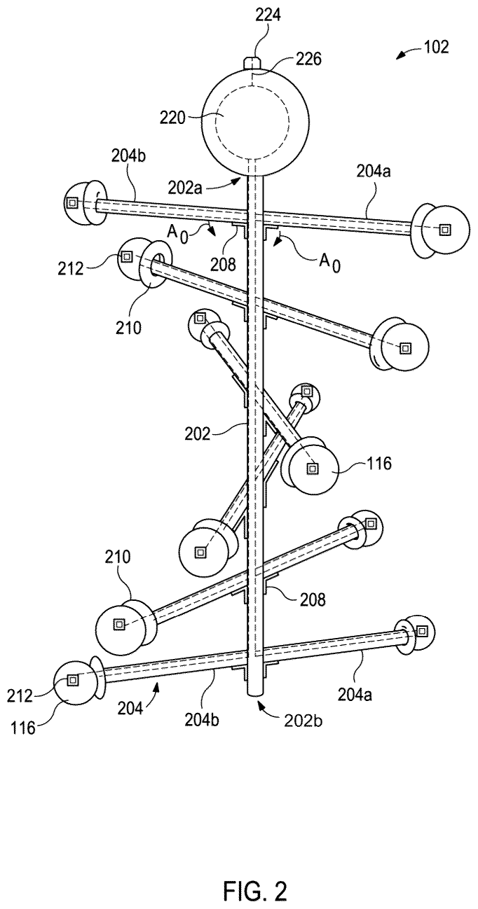

In the illustrated embodiment, the logging tool 102 is deployed into the wellbore 106 on a continuous length of flexible coiled tubing 112 extending from the surface location “S.” In other embodiments, the logging tool 102 may be deployed on other types of conveyance including, but not limited to, wireline, slickline, drill pipe, etc. The coiled tubing 112 may be raised and lowered from the surface location “S” for the selective placement and retrieval of the logging tool 102. The logging tool 102 is illustrated in a retracted configuration where a plurality of impact hammers 116 are spaced from a wellbore wall 118 to allow movement of the logging tool 102 in (through) the wellbore 106. In the retracted configuration, a plurality of arms 204 (FIG. 2) may be arranged generally parallel to a support body 202 (FIG. 2) of the logging tool 102. Once located at an intended or predetermined location within the wellbore 106, the logging tool 102 may be moved (transitioned, actuated, etc.) to an extended configuration where the hammers 116 contact the wellbore wall 118, as described in greater detail below. In addition to the hammers 116, the logging tool 102 may include any number of instruments for gathering pressure, temperature flow data, etc.

A cable 120 may extend along the coiled tubing 112 to place the logging tool 102 in communication with a power system 122 and/or other equipment at the surface location “S.” The cable 120 may include one or more electrical conductors and/or hydraulic conduits, and the power system 122 may include generators for supplying electrical power to the logging tool 102 as well as compressors, accumulators or other hydraulic equipment for supplying hydraulic power to the logging tool 102 through the cable 120.

The coiled tubing 112 and the cable 120 pass from the wellbore 106 through a wellhead 124 located at the surface location “S” and to a trailer 126. The trailer 126 may be used to transport and store various components of the wellbore system 100. For example, the trailer 126 may carry the power system 122, a surface controller 134 and a reel 136 around which the coiled tubing 112 is wound. The surface controller 134 may be operably coupled to the power system 122, the logging tool 102 and/or other components of the wellbore system 100. In some embodiments, the surface controller 134 may be a computer-based system that may include a processor, a memory storage device, and programs and instructions accessible to the processor for executing the instructions utilizing the data stored in the memory storage device. In other embodiments, the surface controller 134 may include manual controls that may be manipulated by an operator to control the logging tool 102 or any of the components of the wellbore system 100.

Referring now to FIG. 2, illustrated is an enlarged view of the downhole logging tool 102 in an extended configuration, where the impact hammers 116 are radially extended from a central support body 202. The central support body 202 is elongated in a longitudinal direction between an uphole end 202a a downhole end 202b. The hammers 116 are supported at radially outermost ends of respective mechanical arms 204a, 204b (generally or collectively referred to as “mechanical arms 204”) coupled to the support body 202. The mechanical arms 204 are arranged in aligned pairs 204a, 204b that together may extend across a diameter of the wellbore 106 and reach the wellbore wall 118 (FIG. 1). The aligned pairs 204a, 204b extend from a common longitudinal position on the support body 202. As illustrated, the logging tool 102 includes six pairs 204a, 204b arranged to extend in different radial directions from the support body 202. In other embodiments, more or fewer pairs 204a, 204b may be provided without departing from the scope of the disclosure. The arms 204 are coupled to the support body 202 by hinges 208 that permit the arms 204 to pivot in the direction of arrows Ao. The pivotal movement of the arms 204 allows the logging tool 102 to move (transition) between the extended configuration, as shown in FIG. 2, and the retracted configuration, as shown in FIG. 1. The arms 204 may be extended and retracted electrically, mechanically, electromechanically, hydraulically, pneumatically, or by other mechanisms recognized in the art. In some embodiments, the arms 204 may be arranged substantially perpendicular to the body 202 when the arms 204 are in an extended position (state) defining the extended configuration of the logging tool 102.

Each hammer 116 is configured generally as a spherical structure provided on the end of the respective mechanical arm 204. The hammers 116 each include a driver 210, which is selectively operable to cause the hammer 116 to deliver an impulse load to the wellbore wall 118 (FIG. 1). The driver 210 may include any electrical, mechanical, hydraulic, or pneumatic mechanisms known in the art for delivering a rapid and precisely controlled impact to the wellbore wall 118. Each of the hammers 116 includes an accelerometer 212 embedded therein for detecting a response to the impact. The accelerometers 212 measure the rate of change of the velocity of the hammer 116, which, during the impulse, corresponds to the impact acceleration experienced by the hammer 116. During the impact, the geological formation “G” defining the wellbore wall 118 (FIG. 1) undergoes elastic deformation, temporarily stretching or compressing before returning to its original state. The accelerometer 212 may quantify the response of the hammer 116 to the motion of the geological formation “G.”

The drivers 210 and accelerometers 212 may be communicatively coupled to a control system 220 coupled to the support body 202, such as at the uphole end 202a. The control system 220 is operable to send control signals to the drivers 210 and receive response signals from the accelerometers 212. Similar to the surface controller 134 (FIG. 1), the control system 220 may be a computer-based system that may include a processor, a memory storage device, and programs and instructions, accessible to the processor for executing the instructions utilizing the data stored in the memory storage device. The control system 220 may be communicatively coupled to the surface controller 134 (FIG. 1) to receive control signals therefrom and to transmit response signals thereto.

The logging tool 102 may include a coupler 224 at or near the uphole end 202a and through which a control cable 226 extending from the control system 220 may be communicatively coupled to the cable 120 (FIG. 1) extending through the coiled tubing 112 (FIG. 1). In other embodiments, the control system 220 may communicate wirelessly with the surface controller 134, and in other embodiments, the control system 220 may communicate with the surface controller 134 only at the surface location “S.” In such embodiments, for example, the control system 220 may be preprogrammed with appropriate instructions prior to the logging tool 102 being deployed downhole, and the control system 220 may store appropriate response signals until the logging tool 102 is withdrawn and may be coupled to the surface controller 134 at the surface location “S” to analyze the stored data.

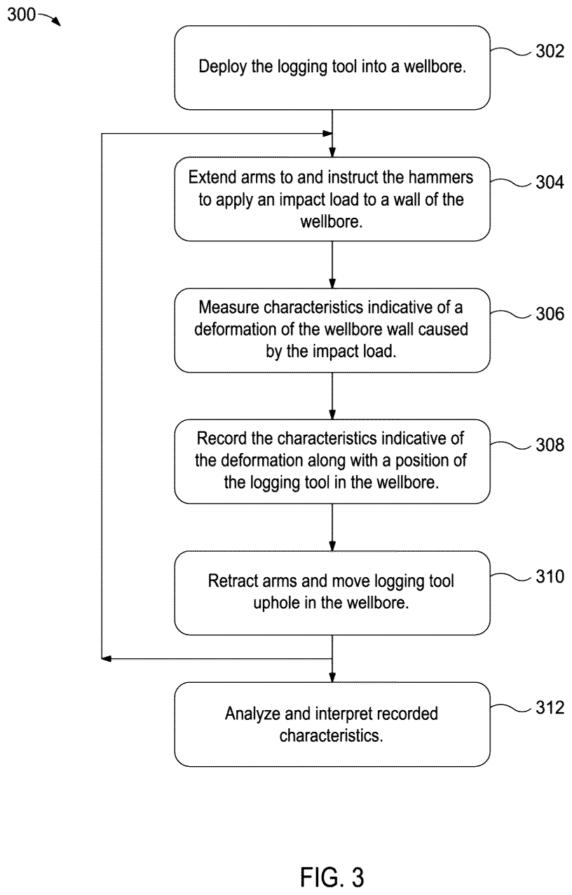

Referring now to FIG. 3, and with continued reference to FIGS. 1 and 2, an example procedure 300 for performing a logging operation with the logging tool 100 is illustrated in accordance with aspects of the present disclosure. The procedure begins at step 302 where the logging tool 102 is deployed into the wellbore 106. The logging tool 102 may be coupled to an end of the coiled tubing 112 or other conveyance at the connector 224. The coiled tubing 112 may be unspooled from the reel 136 to lower the logging tool 102 into the wellbore 106 in its retracted configuration (FIG. 1) where the mechanical arms 204 are arranged alongside the support body 202 and otherwise stowed in a generally downward direction relative to the trajectory of the wellbore 106. The logging tool 102 may be lowered until reaching a first target depth at a lower end of a targeted portion of the wellbore 106 over which the logging operation is to be performed.

Next at step 304, the mechanical arms 204 may be extended, e.g., by unfolding the hinges 208 to extend the arms 204. In some embodiments, the surface controller 134 may send a command signal to the control system 220 through the cable 120 and the control cable 226 to the logging tool 102. The control system 220 may then, in turn, send (transmit) a control signal to one or more pneumatic or electrical actuators (not shown) to extend the arms 204 radially outward. In some embodiments, the actuators may extend the arms 204 to be substantially parallel to the support body 202, as illustrated in FIG. 2. With the logging tool 102 in the extended configuration, the hammers 116 may contact the wellbore wall 118.

With the arms 204 extended, the surface controller 134 and/or control system 220 may send a control signal to the drivers 210 to cause the hammers 116 to apply an impact load to the wellbore wall 118. In some embodiments, the impact load is generated at each hammer 116 on the logging tool 102 simultaneously with an equal magnitude. In other embodiments, the hammers 116 on each pair 204a, 204b of arms 204 generate the impact load simultaneously. All of the hammers 116, each situated at its unique point or location along the wellbore wall 118 generate an impulse load to deliver a rapid and precisely controlled impact to the wellbore wall 118, mimicking the forceful impact of a hammer blow. The simultaneous impact from circumferentially distributed hammers 116 with the same magnitude and timing may allow for more expedient and holistic measurement of the wellbore wall 118 in less time than a single hammer 116.

Next at step 306, characteristics indicative of a deformation of the wellbore wall 118 caused by the impact load may be measured. The accelerometer 212 embedded into each of the hammers 116 measures the rate of change of velocity (acceleration) as a function of time over a period surrounding the application of the impulse load. During the impulse load, the rate of change of velocity corresponds to the impact acceleration experienced by the head of the hammer 116. During this impact, the geologic formation “G” forming the wellbore wall 118 undergoes elastic deformation, temporarily stretching or compressing before returning to its original state. The response of the wellbore wall 118 to the impact load is also measured by the accelerometer 212 in each of the hammers 116.

The procedure 300 may then proceed to step 308 where the data from the accelerometers 212 indicative of the deformation of the wellbore wall 118 is recorded along with the position of the logging tool 102 in the wellbore 106. The deformation measurements made by the accelerometers 212 are recorded as test points and associated with specific depths and/or orientations within the wellbore 118. The deformation measurements may be logged in appropriate data storage media housed within the control system 220, and/or the deformation measurements may be transmitted to the surface controller 134 for logging.

Next at step 310, the mechanical arms 204 may be retracted (radially inward) to separate the hammers 116 from the wellbore wall 118. The actuators (not shown) may again be activated to fold the arms 208 at the hinges 208. The logging tool 102 may then be conveyed uphole to a second target depth in the wellbore 106 that has not yet been logged. The procedure 300 may then return to step 304, where steps 304 through 310 may be repeated as often as necessary to complete a log of the targeted portion of the wellbore 106 over which the logging operation is intended to be performed.

Once the log is completed, the procedure 300 may proceed to step 312 where the characteristics recorded in the log may be analyzed and interpreted. As described above, the log includes a detailed record of how an acceleration varies over the course the impacts imparted at various locations in the wellbore 106. Using Newton's second law (F=ma), where “F” is force, “m” is a mass of the hammer 116, and “a” is acceleration, the acceleration recorded by the accelerometers 212 allows for the calculation of the force applied by the hammers 116 and the wellbore wall 118 during the impact. In the case of the logging tool 102, the elastic Hertzian contact model is used convert collected data into usable mechanical properties values for the operator (geologists, researchers, engineers, etc.) to consider. The Hertzian model describes the impact of a sphere (an approximation for hammers 116) with an infinite sheet (an approximation for the wellbore wall 118). Using the force-time function calculated using Newton's second law, the Hertzian contact model described by Equation 1 below may be applied.

$$f ( t ) ≅ H ( \frac{4}{3} ) {R}^{\frac{1}{2}} ε * {d}^{\frac{3}{2}} \qquad ( Eq . 1 )$$

$$where ,$$

$$H = dimensionless hardness parameter$$

$$R = radius of the spherical hammer 116$$

$$ε *= facter representing the impactor ’ s ( hammer 116 ) mechanical behavior$$

$$d = deformation or indentation casued by impact$$

From Equation 1 above, the dimensionless hardness parameter (H), as well as a reduced Young's modulus (E*) of the wellbore wall 118 may be obtained. The reduced Young's modulus E* is a dimensionless material property often used in mechanics and material science to compare the stiffness or elasticity of different materials. The reduced Young's modulus E* of the wellbore wall 118 is the factor ε* representing the mechanical behavior of the hammer 116 adjusted for the Poisson ratio and Young's modulus of the hammer 116 (see Equations 5 and 6 below). The dimensionless hardness parameter H is a numerical value used to describe the hardness of a material. Hardness is a measure of a material's resistance to deformation, typically by indentation or scratching. Together the hardness parameter H and the reduced Young's modulus E* may effectively describe the mechanical behavior of the wellbore 106.

The elastic Hertzian solution uses the velocity measured by accelerometers 212 to calculate the deformation of the wellbore wall 118 as a function of time d (t) Equations 2 through 6 as presented below.

$$d ( t ) ≅ sin ( \frac{π ( t - {t}_{0} )}{2 T *} ) {d}_{max} \qquad ( Eq . 2 )$$

$${d}_{max} = {( \frac{15 M {V}^{2}}{16 \sqrt{R} {ε}^{*}} )}^{\frac{2}{5}} \qquad ( Eq . 3 )$$

$$T *= 2.94 ( \frac{{d}_{max}}{2 V} ) \qquad ( Eq . 4 )$$

$$\frac{1}{ε} * = \frac{1 - {v}_{tip}^{2}}{{E}_{tip}} + \frac{1}{E *} \qquad ( Eq . 5 )$$

$$E *= \frac{E}{1 - {v}^{2}} \qquad ( Eq . 6 )$$

$$where ,$$

$${t}_{0} = time of impact$$

$$M = mass of the impactor ( hammer 116 )$$

$$V = velocity of impact$$

$${v}_{tip} = Poisson ’ s ratio of the hammer 116$$

$${E}_{tip} = Young ’ s modulus of the hammer 116$$

$$E = wellbore wall 118 rock Young ’ s modulus ; and$$

$$v = wellbore wall rock Poisson ’ s ratio$$

This comprehensive data analysis of step 310, which incorporates the Hertzian contact model, allows for the calculation of the wellbore's elasticity, stiffness, and deformation characteristics at various depths in the wellbore 106. It should be appreciated that the procedure 300 may be performed with certain modifications including performing steps in a different order or eliminating certain steps.

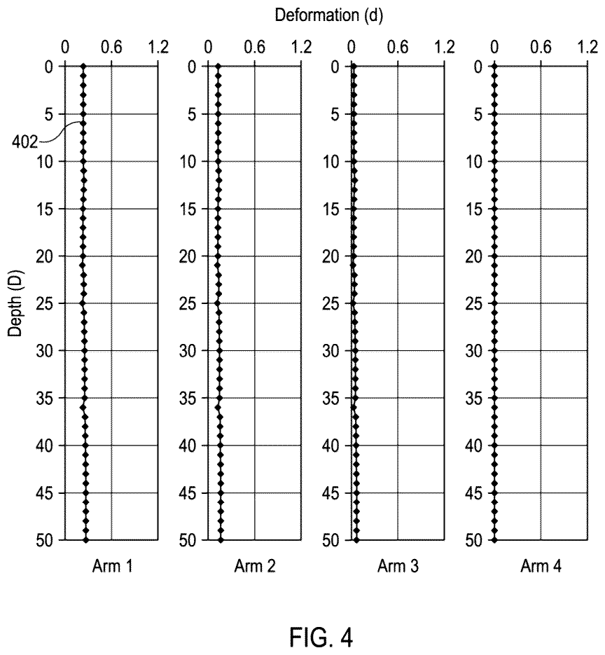

As illustrated in FIG. 4, the horizontal change (deformation) of the wellbore wall 118, once determined in step 310, may be recorded and be illustrated as logs of deformation vs. depth in the wellbore for each arm 204. In other embodiments, similar deformation vs. time logs may be generated by employing a time and depth tracker included in the downhole tool 102. Each individual arm 204 (designated Arms 1-4) may represent an orientation in the wellbore 106. Each impact may be represented by a data point 402 at different depths in the wellbore. Because each arm is oriented in a in a different direction, each hammer 116 may engage a different lithology exhibiting a different mechanical behavior. For example, as indicated in FIG. 4, arms 1 and 2 record a greater deformation than arms 3 and 4. The logs may be examined for identifiable trends in the data. For example, FIG. 4 illustrates an increase in deformation as the depth increases. The data illustrated in FIG. 4, is illustrative only, and different wellbores may produce different logs.

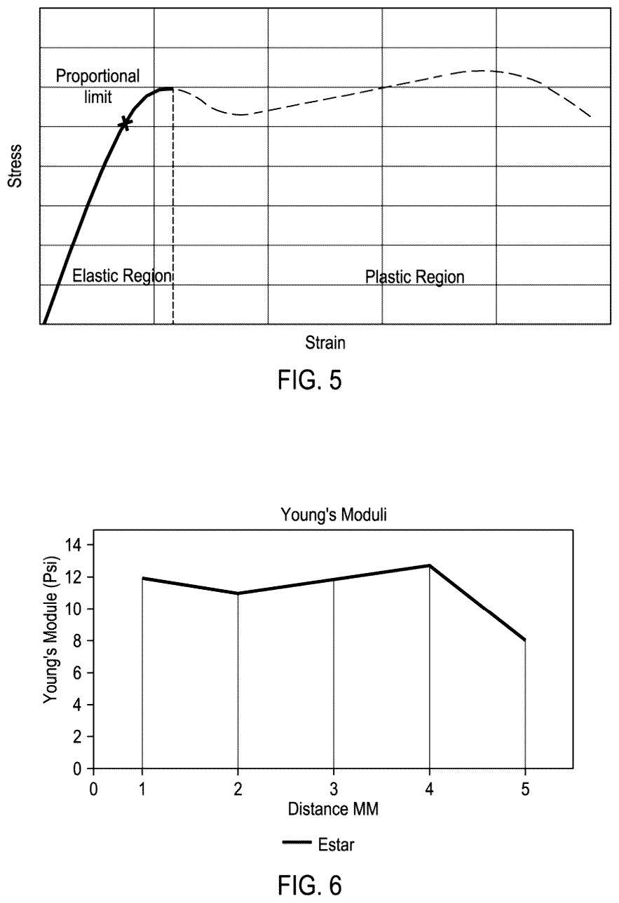

Referring to FIG. 5, a graphical illustration of a stress strain curve for a particular wellbore 106 that may be generated from measurements made by the logging tool 102. Deformation obtained from logs may represent strain and the magnitude of the compressional impact load applied by the logging tool may be represented by stress. The logging tool 102 may be employed to apply impact loads below the proportional limit of the geological formation “G” beyond which the rock material starts exhibiting plastic deformation. Thus, the stress-strain curve obtained may represent the elastic region only. As illustrated in FIG. 5, the elastic region manifests as a linear correlation between applied stress and the resulting strain, signifying the capacity of the geological formation “G” to undergo reversible deformation. A meticulous identification of this elastic segment may be extremely valuable to an operator, offering valuable insights for wellbore stability assessments and drilling strategy optimizations.

Referring to FIG. 6, a graphical illustration of an impulse hammer curve representing Young's modulus measurements made by the logging tool 102 in a lab setting is illustrated. The Young's modulus generally represents the slope of the linear correlation illustrated in the elastic portion of the curve illustrated in FIG. 5. FIG. 6 indicates that the Young's modulus curve could be generated in a lab setting using the same procedure described above by deploying the logging tool 102 in a wellbore.

Embodiments disclosed herein include:

A. A wellbore system including a conveyance extending into a wellbore from a surface location and a logging tool coupled to an end of the conveyance such that the logging tool may be moved through the wellbore on the conveyance. The logging tool includes a support body coupled to the conveyance, a plurality of arms selectively movable from a retracted position to an extended position with respect to the support body, a hammer supported at radially outermost end of each of the arms, the hammer selectively operable to deliver an impulse load to a wall of the wellbore when the arms are in the extended position, and one or more accelerometers operably coupled to each hammer and operable to detect an acceleration of the hammer induced by delivering the impulse load.

B. A method of conducting a logging operation in a wellbore that includes (a) deploying a logging tool to a first target location in the wellbore on a conveyance, (b) moving a plurality of arms carried by the logging tool from a retracted position to an extended position wherein a hammer disposed at a radially outer end of each of the arms engages a wall of the wellbore at a plurality of distinct points at the first target location, (c) delivering an impulse load to the wellbore wall by each of the hammers (d) measuring an acceleration of the hammer during the impulse load, and (e) determining at least one characteristic of the wellbore wall from the acceleration of the hammers at the plurality of distinct points.

C. A wellbore logging tool that includes a support body elongated in a longitudinal direction, a plurality of arms selectively movable from a retracted position to an extended position with respect to the support body, a hammer supported at radially outermost end of each of the arms, the hammers selectively operable to deliver an impulse load to a wall of the wellbore when the arms are in the extended position, and one or more accelerometers operably coupled to each hammer and operable to detect an acceleration of the hammer induced by delivering the impulse load.

Each of embodiments A through C may have one or more of the following additional elements in any combination: Element 1: wherein the plurality of arms includes at least one pair of aligned arms operable to extend across a diameter of the wellbore when the arms are in the extended position. Element 2: wherein the at least one pair of aligned arms includes a plurality of pairs of aligned arms, the pairs of aligned arms longitudinally spaced from one another along the support body. Element 3: wherein each pair of aligned arms extends in a different radial direction from the support body such that the hammers are circumferentially distributed about the wellbore wall. Element 4: wherein the plurality of arms is coupled to the support body by hinges operable to fold the arms between the retracted position and the extended position. Element 5: wherein the arms are generally parallel with the support body when arranged in the retracted position and are generally perpendicular with the support body when arranged in the extended position. Element 6: wherein the logging tool further comprises a control system operably coupled each of the hammers to send a control signal thereto to cause the hammers to deliver the impulse load and operably coupled to the one or more accelerometers to receive response signals therefrom indicative of an acceleration of each of the hammers during the impulse load. Element 7: further comprising a surface controller disposed at the surface location, the surface controller communicatively coupled to the control system of the logging tool by a cable extending along the conveyance.

Element 8: wherein delivering the impulse load includes impacting the wellbore wall with an equal force simultaneously with each of the hammers at the plurality of distinct points. Element 9: wherein impacting the wellbore wall at the plurality of distinct points includes impacting the wellbore wall with an equal force simultaneously with hammers carried by at least one pair of the arms aligned with one another to extend across a diameter of the wellbore. Element 10: wherein impacting the wellbore wall with an equal force simultaneously further includes impacting the wellbore wall with hammers carried by arms of the plurality of arms longitudinally spaced from the at least one pair of the arms aligned with one another. Element 11: wherein determining at least one characteristic of the wellbore wall includes determining at least one of a hardness parameter or a reduced Young's modulus of the wellbore wall. Element 12: wherein determining the at least one characteristic of the wellbore wall includes calculating the hardness parameter or the reduced Young's modulus with a Hertzian model. Element 13: further comprising: retracting the plurality of arms to disengage the hammers from the wellbore wall; conveying the logging tool longitudinally from the first target location to a second target location in the wellbore; and re-extending the arms to engage the wellbore wall at the second target location.

Element 14: further comprising a control system disposed at a downhole end of the support body and operably coupled each of the hammers to send a control signal thereto to cause the hammers to deliver the impulse load and operably coupled to the one or more accelerometers to receive response signals therefrom indicative of an acceleration of each of the hammers during the impulse load. Element 15: wherein the control system is operable to cause each of the hammers to impact the wellbore wall with an equal force simultaneously to thereby deliver the impulse load. Element 16: wherein the plurality of arms is radially and longitudinally spaced from one another. Element 17: wherein the wherein the plurality of arms includes at least one pair of aligned arms operable to extending from a common longitudinal location of the support body such that the at least one pair of aligned arms are operable to extend across a diameter of the wellbore when the arms are in the extended position.

By way of non-limiting example, exemplary combinations applicable to A through C include: Element 1 with Element 2; Element 2 with Element 3; Element 4 with Element 5; Element 6 with Element 7; Element 8 with Element 9; Element 9 with Element 10; Element 11 with Element 12; Element 14 with Element 15; and Element 16 with Element 17.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such. While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A wellbore system, comprising:
a conveyance extending into a wellbore from a surface location; and
a logging tool operatively coupled to an end of the conveyance such that the logging tool is movable through the wellbore on the conveyance, the logging tool including:
a support body operatively coupled to the conveyance;
a plurality of arms selectively movable from a retracted position to an extended position with respect to the support body;
a hammer supported at a radially outermost end of each arm, the hammer being selectively operable to deliver an impulse load to a wall of the wellbore when the plurality of arms is in the extended position; and
one or more accelerometers operably coupled to each hammer and operable to detect an acceleration of the hammer induced by delivering the impulse load.

2. The wellbore system of claim 1, wherein the plurality of arms includes at least one pair of aligned arms operable to extend across a diameter of the wellbore when the plurality of arms is in the extended position.

3. The wellbore system of claim 2, wherein the at least one pair of aligned arms includes a plurality of pairs of aligned arms, each pair of aligned arms being longitudinally spaced from one another along the support body.

4. The wellbore system of claim 3, wherein each pair of aligned arms extends in a different radial direction from the support body such that the hammers are circumferentially distributed about the wellbore wall.

5. The wellbore system of claim 1, wherein the plurality of arms is coupled to the support body by hinges operable to fold the arms between the retracted and extended positions.

6. The wellbore system of claim 5, wherein the plurality of arms is arranged generally parallel with the support body when in the retracted position and arranged generally perpendicular with the support body when in the extended position.

7. The wellbore system of claim 1, wherein the logging tool further comprises a control system in communication with each hammer to send a control signal that causes the hammer to deliver the impulse load, and further in communication with the one or more accelerometers to receive response signals indicative of an acceleration of each hammer during the impulse load.

8. The wellbore system of claim 7, further comprising a surface controller disposed at the surface location and communicatively coupled to the control system by a cable extending along the conveyance.

9. A method of conducting a logging operation in a wellbore, the method comprising:
deploying a logging tool on a conveyance to a first target location in the wellbore;
moving a plurality of arms operatively coupled to the logging tool from a retracted position to an extended position, where a hammer disposed at a radially outer end of each arm engages a wall of the wellbore at a plurality of distinct points at the first target location;
delivering an impulse load to the wellbore wall with each hammer;
measuring an acceleration of the hammer during the impulse load; and
determining at least one characteristic of the wellbore wall from the acceleration of the hammer at the plurality of distinct points.

10. The method of claim 9, wherein delivering the impulse load includes impacting the wellbore wall with an equal force simultaneously with each hammer at the plurality of distinct points.

11. The method of claim 10, wherein impacting the wellbore wall at the plurality of distinct points includes impacting the wellbore wall with an equal force simultaneously with corresponding hammers carried by at least one pair of the plurality of arms aligned with one another to extend across a diameter of the wellbore.

12. The method of claim 11, wherein impacting the wellbore wall with an equal force simultaneously further includes impacting the wellbore wall with the corresponding hammers carried by corresponding arms of the plurality of arms longitudinally spaced from the at least one pair of the arms aligned with one another.

13. The method of claim 9, wherein determining at least one characteristic of the wellbore wall includes determining at least one of a hardness parameter or a reduced Young's modulus of the wellbore wall.

14. The method of claim 13, wherein determining the at least one characteristic of the wellbore wall includes calculating the hardness parameter or the reduced Young's modulus with a Hertzian model.

15. The method of claim 9, further comprising:
retracting the plurality of arms to disengage the hammers from the wellbore wall;
conveying the logging tool longitudinally from the first target location to a second target location in the wellbore; and
transitioning the plurality of arms back to the extended position to engage the wellbore wall at the second target location.

16. A wellbore logging tool, comprising:
a support body elongated in a longitudinal direction;
a plurality of arms pivotably coupled to the support body and selectively movable from a retracted position to an extended position with respect to the support body;
a hammer supported at a radially outermost end of each arm, the hammer being selectively operable to deliver an impulse load to a wall of the wellbore when the plurality of arms is in the extended position; and
one or more accelerometers operably coupled to each hammer and operable to detect an acceleration of the hammer induced by delivering the impulse load.

17. The wellbore logging tool of claim 16, further comprising a control system operatively coupled to the support body and in communication with each hammer to send a control signal that causes each hammers to deliver the impulse load, the control system being further in communication with the one or more accelerometers to receive response signals indicative of an acceleration of each hammer during the impulse load.

18. The wellbore logging tool of claim 17, wherein the control system is operable to cause each hammer to impact the wellbore wall with an equal force simultaneously to thereby deliver the impulse load.

19. The wellbore logging tool of claim 16, wherein the plurality of arms is radially and longitudinally spaced from one another.

20. The wellbore logging tool of claim 19, wherein the wherein the plurality of arms includes at least one pair of aligned arms extending from a common longitudinal location of the support body such that the at least one pair of aligned arms extend across a diameter of the wellbore when in the extended position.
